(19) United States
(12) Patent Application Publication
(10) Pub. No.: US 2024/0390992 A1
(43) Pub. Date: Nov. 28, 2024

(54) Split Hole Saw Bit Device

(71) Applicant: Michael Fisher, Loysville, PA (US)

(72) Inventor: Michael Fisher, Loysville, PA (US)

(21) Appl. No.: 18/648,675

(22) Filed: Apr. 29, 2024

Related U.S. Application Data
(60) Provisional application No. 63/504,320, filed on May 25, 2023.

(51) Int. Cl. B23B 51/04

(52) U.S. Cl. CPC B23B 51/0426

(57) ABSTRACT

A split hole saw bit designed for efficiently cutting circular holes in wood and simplifying the removal of the cut portion of wood (i.e., plug) from within the saw bit is disclosed. The bit comprises first and second semi-cylindrical members that, when assembled, form a circular bit equipped with cutting teeth at their bottom ends for initiating and performing the cut. A center pilot bit extends below the circular bit, designed to drill ahead, thereby facilitating the start of the cutting operation. The semi-cylindrical members are secured together using a nut having an integrated stopper which secures the semi-cylindrical members and prevents vertical movement of the center pilot bit during use. The drill head of the center pilot can be used with any drill and the bit enables easy detachment of the semi-cylindrical members for quick removal of the wood plug.

### CROSS-REFERENCE TO RELATED APPLICATION

The present application claims priority to, and the benefit of, U.S. Provisional Application No. 63/504,320, which was filed on May 25, 2023, and is incorporated herein by reference in its entirety.

### FIELD OF THE INVENTION

The present invention generally relates to the field of drill bits. More specifically, the present invention relates to a novel saw bit designed to cut circular holes into wood. The bit is split down the center and held together with a nut, with cutting teeth on the bottom. A center pilot bit enables for smoother cutting. Once a user has cut through the wood, the nut can be turned out which holds the pilot bit and both halves in place to remove the sawed piece. Accordingly, the present disclosure makes specific reference thereto. Nonetheless, it is to be appreciated that aspects of the present invention are also equally applicable to other like applications, devices, and methods of manufacture.

### BACKGROUND

By way of background, cut pieces or plugs such as circular pieces/plugs are commonly required to be removed from the center of a wooden piece. Often, a hole saw and drill bit setup is required to cut through a wood piece. Wood density can vary significantly depending on the type of the wood and the offered resistance may require the drill to work harder, thereby slowing down the cutting process. As the hole saw rotates, friction generates heat, which can cause the wood to burn or the saw's teeth to dull. Standard hole saws are designed to remove a circular section or plug of material, but they often lack efficient means to clear the sawdust and chips generated during cutting. Accordingly, using a standard hole saw and drill bit setup can be a slow and cumbersome process. Further, using a drill with a conventional hole saw device is difficult. Individuals may find challenge in connecting the hole saw with the drill.

Individuals also have trouble in prying out the cut piece or plug, particularly in tight or deep cuts using conventional hole saws. As the hole saw cuts through wood, friction generates heat, causing the wood fibers around the cut to expand and potentially bind to the saw's inner walls. Many standard hole saws do not come with an efficient mechanism for ejecting the cut piece or plug once the hole is cut. As a result, the plug remains lodged inside the saw until manually removed by applying a lot of force. The design of the teeth on some hole saws can exacerbate the issue by gripping the plug too tightly. This is particularly true in hole saws designed for a clean cut, where the teeth may dig into the plug, securing it firmly within the cavity of the cylinder of the saw bit. Making initial penetration in a wood item is difficult using the conventional hole saws. Individuals desire an improved hole saw bit that is designed to address the common challenges encountered when cutting circular holes in wood.

Therefore, there exists a long felt need in the art for an improved hole saw bit that simplifies the process of removing the cut portion or piece of wood (i.e., plug) from within the cavity of the cylinder of the circular saw bit. There is also a long felt need in the art for a hole saw bit that can split into two halves to simplify the process of removing the cut portion of wood (i.e., plug) from within the saw bit. Additionally, there is a long felt need in the art for a novel hole saw bit system that includes a center pilot bit for guiding the hole saw in cutting the hole. Moreover, there is a long felt need in the art for a novel hole saw bit that has cutting teeth at the bottom end for reducing force required to make a cut in the wood. Further, there is a long felt need in the art of a specially designed hole saw bit that includes a nut to hold both halves of the saw together while attached to the drill bit thereby ensuring that the tool maintains structural integrity and safety during operation. Furthermore, there is a long felt need in the art for a hole saw bit system that can be used for different types of wood. Finally, there is a long felt need in the art for a split hole saw bit that easily cuts circular holes into wood saving considerable time and effort for users.

The subject matter disclosed and claimed herein, in one embodiment thereof, comprises a split hole saw bit device. The device comprises two semi-cylindrical or semi-circular members forming a circular bit, each member having complementary threaded edges along their longitudinal sides for secure engagement, each semi-cylindrical or semi-circular member having a top threaded member, a central opening formed by the joined top threaded members of the semi-cylindrical or semi-circular members, a center pilot bit adapted to pass through the central opening including a stopper to prevent vertical movement during operation, the stopper is integrated to a nut, the nut is adapted to threadably engage the threaded top ends to hold the two semi-cylindrical or semi-circular members together. The center pilot bit is configured to drill ahead (i.e., upstream) of the circular bit, facilitating the start of a cutting operation and a plurality of the teeth at the bottom edge of the two semi-cylindrical or semi-circular members cuts a circular piece from wood.

In this manner, the split hole saw bit device of the present invention accomplishes all of the forgoing objectives and provides users with a hole saw bit device that splits in half to simplify the process of removing the cut portion of wood from within the saw bit. The device reduces the frustration and time involved in prying out the plug, particularly in tight or deep cuts. The bit has an associated pilot bit and cutting teeth on the bottom so that the tool can start cutting into the wood surface immediately and with less force required. The hole saw bit maintains structural integrity and safety during operation. The device enables for straightforward assembly and disassembly, facilitating quick setup and breakdown times, as well as making it easier to clean and maintain the tool.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a split hole saw bit device. The device comprises two semi-cylindrical or semi-circular members forming a circular bit, each semi-cylindrical or semi-circular member having complementary threaded edges along their longitudinal sides for secure engagement, each member having a top threaded member, a central opening formed by the joined top threaded members of the semi-cylindrical or semi-circular members, a center pilot bit adapted to pass through the central opening including a stopper to prevent vertical movement during operation, the stopper is integrated to a nut, the nut is adapted to threadably engage the threaded top ends to hold the two semi-cylindrical or semi-circular members together. The center pilot bit is configured to drill ahead of the circular bit, facilitating the start of a cutting operation and a plurality of the teeth at the bottom edge of the two semi-cylindrical or semi-circular members cuts a circular piece or plug of wood from the surrounding wood article.

In another aspect, a split hole saw bit is disclosed. The split hole saw bit comprises a first semi-cylindrical or semi-circular member that has a threaded top end member and a plurality of cutting teeth at the bottom end thereof. A second semi-cylindrical or semi-circular member has a threaded top end member and a plurality of cutting teeth at the bottom end, wherein the first and second semi-cylindrical or semi-circular members are adapted to be joined along their threaded longitudinal edges. A nut is configured to threadably engage the threaded top ends of the first and second semi-cylindrical or semi-circular members to hold them together. The plurality of cutting teeth on the bottom ends of the first and second semi-circular members are arranged to cut a circular hole in wood.

In yet another embodiment, a hole saw bit device designed for cutting circular holes in wood is disclosed. The hole saw bit device includes a hole saw bit which has a first and second semi-cylindrical or semi-circular members, each with a second bottom end equipped with cutting teeth, a nut for securing the threaded top ends of the semi-cylindrical or semi-circular members together, a center pilot bit adapted to pass through a central opening formed the threaded top ends, the center pilot bit being detachably attached (i.e., selectively attached) and extending below the bottom ends of the semi-cylindrical or semi-circular members, and a stopper attached to the nut for preventing or restricting vertical movement of the center pilot bit during use. The top surface of the first and second semi-cylindrical or semi-circular members include collars wherein the vertical arms of the stopper abut against the collars for preventing or restricting the vertical movement of the center pilot bit and securing the first and second semi-cylindrical or semi-circular members together.

In a further embodiment, the hole saw bit is formed by joining the first and the second semi-cylindrical or semi-circular member, each having cutting teeth at their bottom ends. The center pilot bit drills ahead (i.e., upstream) of the circular bit to facilitate the start of the cutting operation. The nut along with the stopper secures the semi-cylindrical or semi-circular members together during drilling and the nut when unscrewed after drilling enables the semi-cylindrical or semi-circular members to be separated, thereby reducing effort, time, and frustration in making circular holes in wood pieces and removing a sawed piece or plug from the saw bit.

In another aspect, the stopper is integrated to the nut and includes a pair of L-shaped arms, each arm having a vertical component and a horizontal component, wherein the vertical components are adapted to extend downwardly to engage with semi-cylindrical or semi-circular members of the split hole saw bit. The nut to which the L-shaped arms are rigidly attached (i.e., fixed) is configured to threadably engage with threaded top ends of the semi-cylindrical or semi-circular members, thereby securing the semi-cylindrical or semi-circular members together in an assembled position.

The center pilot bit includes a threaded bit member extending from a first top end to a second bottom end, wherein the bottom end of the center pilot bit is designed to extend below the bottom ends of the circular bit which is formed by joining a first and a second semi-cylindrical or semi-circular members. The center pilot bit is positioned to drill ahead (i.e., upstream) of the circular bit during the cutting operation, ensuring an initial penetration into the wood surface before the engagement of the circular bit's cutting teeth with the wood, thereby facilitating the start of the cutting process and improving the efficiency and accuracy of the hole cutting operation.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the split hole saw bit device of the present invention in an assembled form in accordance with the disclosed structure;

FIG. 2 illustrates a perspective view showing the semi-cylindrical halves in a detached or split position in accordance with the disclosed structure;

FIG. 3 illustrates a planar view showing the semi-cylindrical halves with attached threaded edges and the nut without the stopper in accordance with the disclosed structure;

FIG. 4 illustrates a standalone view of the center pilot bit in accordance with one embodiment of the present invention;

FIG. 5 illustrates a top perspective view of the hole saw bit in accordance with one embodiment of the present invention; and

FIG. 6 illustrates a perspective view of use of the split hole saw bit device for removing a circular plug in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved hole saw bit that simplifies the process of removing the cut portion of wood (i.e., plug) from within the saw bit. There is also a long felt need in the art for a hole saw bit that can split into two halves to simplify the process of removing the cut portion of wood (i.e., plug) from within the saw bit. Additionally, there is a long felt need in the art for a novel hole saw bit system that includes a center pilot bit for guiding the hole saw in cutting the hole. Moreover, there is a long felt need in the art for a novel hole saw bit that has cutting teeth at the bottom end for reducing force required to make a cut in the wood. Further, there is a long felt need in the art of a specially designed hole saw bit that includes a nut to hold both halves of the saw together while attached to the drill bit thereby ensuring that the tool maintains structural integrity and safety during operation. Furthermore, there is a long felt need in the art for hole saw bit system that can be used for different types of wood. Finally, there is a long felt need in the art for a split hole saw bit that easily cuts circular holes into wood saving considerable time and effort for users.

The present invention, in one exemplary embodiment, is a hole saw bit device designed for cutting circular holes in wood. The hole saw bit device includes a hole saw bit which has a first and a second semi-cylindrical or semi-circular members, each with a second bottom end equipped with cutting teeth, a nut for securing the threaded top ends of the semi-cylindrical or semi-circular members together, a center pilot bit adapted to pass through a central opening formed in the threaded top ends, the center pilot bit being detachably attached (i.e., selectively attached) and extending below the bottom ends of the semi-cylindrical or semi-circular members, and a stopper attached to the nut for preventing or restricting vertical movement of the center pilot bit during use. The top surface of the first and second semi-cylindrical or semi-circular members include collars wherein the vertical arms of the stopper abut against the collars for preventing or restricting the vertical movement of the center pilot bit and for securing the first and second semi-cylindrical or semi-circular members together.

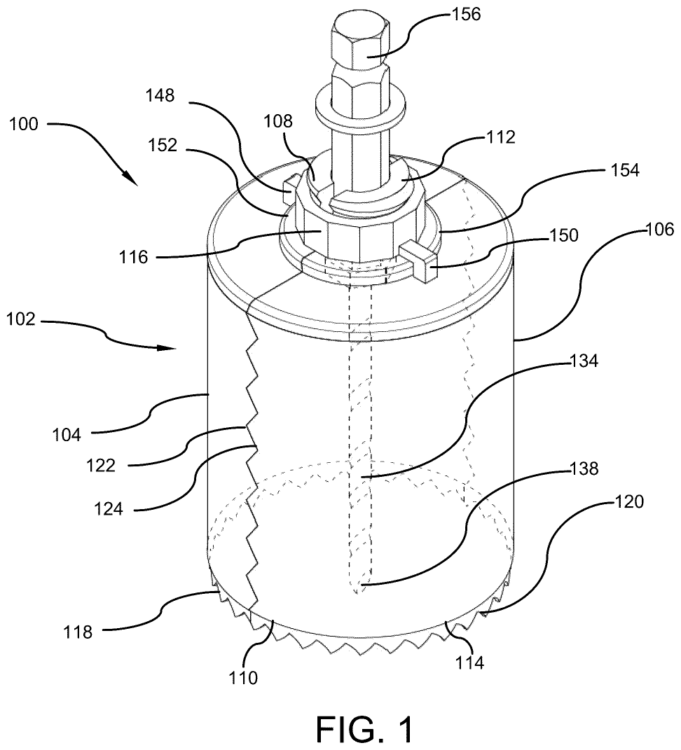

Referring initially to the drawings, FIG. 1 illustrates a perspective view of the split hole saw bit device of the present invention in an assembled form in accordance with the disclosed structure. The split hole saw bit 100 of the present invention is designed as an improved saw bit to cut circular holes into wood and to simplify the process of removing the cut portion of wood (i.e., plug) from within the saw bit. The split hole saw bit 100 has a unique design and includes a circular bit 102 which is preferably circular for cutting circular holes in wood.

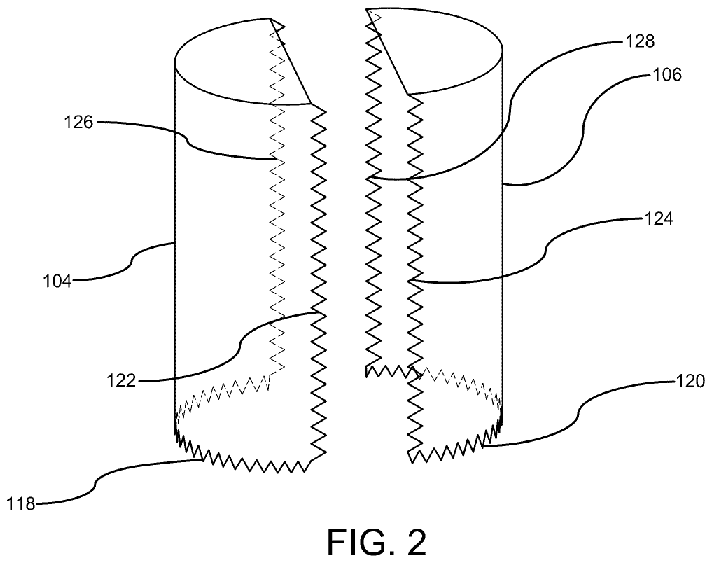

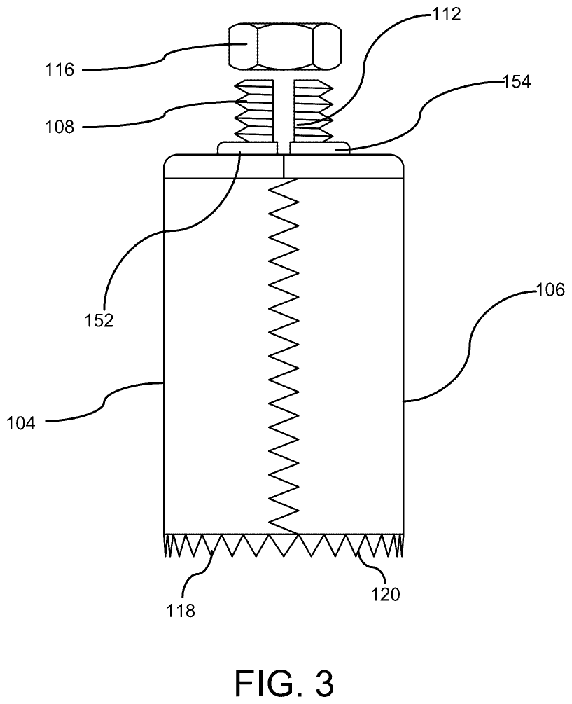

Referring to FIGS. 1, 2, and 3, the circular bit 102 has a first semi-circular member 104 and a second semi-circular member 106. The first semi-cylindrical or semi-circular member 104 has a threaded top end member 108 and a bottom end 110. The second semi-cylindrical or semi-circular member 106 has a threaded top end member 112 and a bottom end 114. In the assembled position, the threaded top end members 108, 112 are joined using a nut 116 which holds the semi-cylindrical or semi-circular members/halves 104, 106 together. The nut 116 is threaded around the top end members 108, 112 for securing the halves 104, 106. The bottom ends 110, 114 have a plurality of cutting teeth 118, 120 respectively for cutting a circular hole in wood. The cutting teeth 118, 120 on the bottom of the semi-cylindrical or semi-circular members 104, 106 ensures that the tool 100 can start cutting into the wood surface immediately and with less force required. The cutting teeth 118, 120 also provides consistent engagement with the material throughout the cutting process.

In the assembled form, the first longitudinal threaded or mating edge 122 of the first semi-circular member 104 secures against the first longitudinal threaded or mating edge 124 of the second semi-circular member 106. Similarly, the second longitudinal threaded or mating edge 126 of the first semi-circular member 104 secures to the second longitudinal threaded or mating edge 128 of the second semi-circular member 106 to form the circular bit 102. The longitudinal threaded or mating edges 122, 124 have complimentary threads and/or edges and/or edges 126, 128 also have complimentary threads and/or edges for secure engagement of the semi-circular members 104, 106. The circular bit 102 can be designed to have different diameters to accommodate different user requirements.

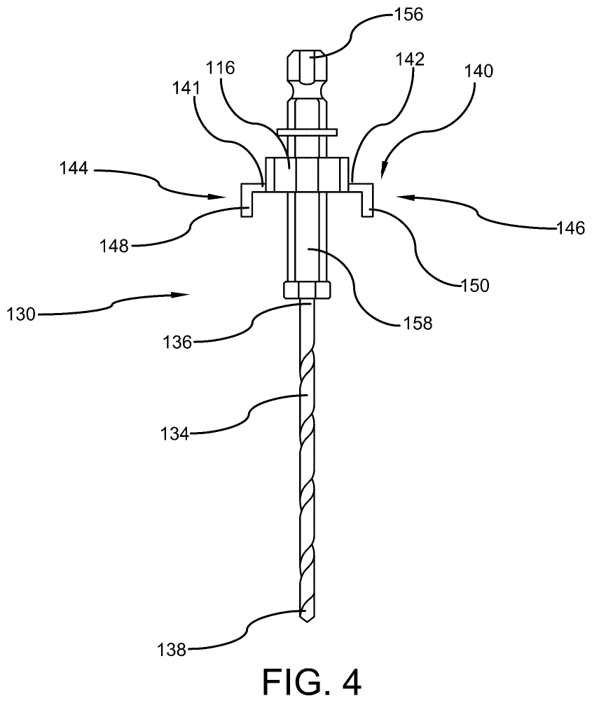

Referring now to FIGS. 1, 4, and 5, a center pilot bit 130 is provided with the split hole saw bit device 100. The center pilot bit 130 is adapted to pass through the central opening 132 of the circular bit 102. The central opening 132 is formed by the top ends 108, 112 of the saw bit 102. The center pilot bit 130 includes a fluted drill member 134 extending from a first top end 136 to the bottom end 138. The fluted drill member 134 can be detachably attached (i.e., selectively attached) to the center pilot bit 130. As illustrated in FIG. 1, the bottom end 138 of the center pilot bit 130 extends below the bottom ends 110, 114 of the circular bit 102 and drills ahead (i.e., upstream) of the circular bit 102.

The center pilot bit 130 has a stopper 140 which prevents any vertical movement of the center pilot bit 130 when used with a drill for making a circular cut in wood. The stopper 140 is rigidly attached (i.e., fixed) to the opposite ends 141, 142 of the nut 116. The stopper 140 includes a pair of two L-shaped arms 144, 146. The first arm 144 is integrated to the first end 141 and the second arm 146 is integrated to the second end 142. The vertical arm 148 of the first arm 144 and the vertical arm 150 of the second arm 146 downwardly extend and are adapted to secure the semi-cylindrical or semi-circular members 104, 106. The first vertical arm 148 is positioned adjacent to the first collar 152 and the second vertical arm 150 is positioned adjacent to the second collar 154. The collar 152 is disposed on the first semi-cylindrical or semi-circular member 104 and the collar 154 is disposed on the second semi-cylindrical or semi-circular member 106.

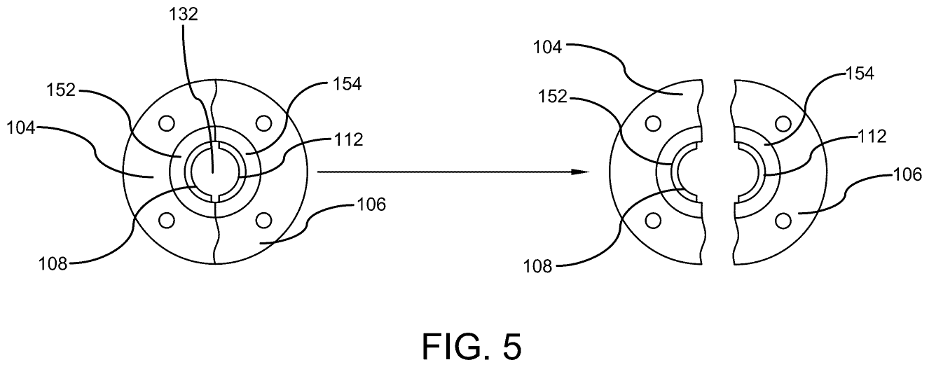

The drill head 156 of the center pilot bit 130 is used for connection to a drill for rotating the center pilot bit 130 to cut through wood, thereby also enabling the attached bit 102 to make a circular cut in the wood. The nut 116 and the stopper 140 secure the semi-cylindrical or semi-circular members 104, 106 along with the center pilot bit 130 to assemble the device 100. As illustrated in FIG. 5, the center opening 132 of the circular bit 102 is formed by the top ends 108, 112 and is used for accommodating the center pilot bit 130 therethrough and is stopped by the stopper 140. The halves 104, 106 are split or detached easily by removing the stopper 140 by unscrewing the nut 116 to remove a sawed piece accommodated in the hole saw bit 102.

The pin sleeve 158 provides a smooth surface for the halves 104, 106 of the hole saw bit 102 to rotate around or to maintain alignment. The sleeve 158 may help to keep the circular bit 102 in correct alignment while also enabling the halves 104, 106 to separate when needed, such as when removing the cut wood plug.

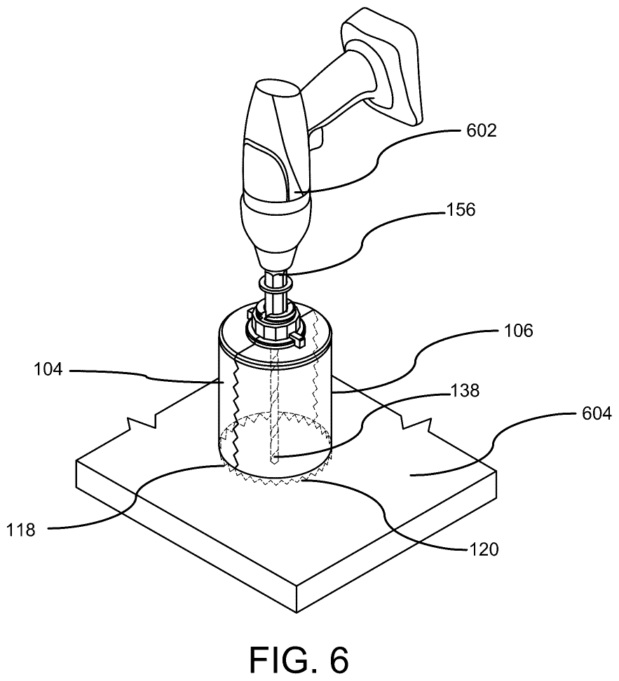

FIG. 6 illustrates a perspective showing use of the split hole saw bit of the present invention for cutting a circular hole in a wood piece in accordance with the disclosed structure. As illustrated, the drill head 156 is attached to a drill 602 which can be a handheld drill device. The bottom end 138 of the fluted drill member 134 moves ahead of the bottom teeth 118, 120 of the circular bit 102. The removed wooden plug from the wood piece 604 can be easily removed by splitting the halves 104, 106 after use of the device 100, thereby reducing the effort, time, and frustration of operators to make circular holes in wood pieces.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “split hole saw bit”, “split hole saw bit device”, and “device” are interchangeable and refer to the split hole saw bit device 100 of the present invention.

Notwithstanding the forgoing, the split hole saw bit device 100 of the present invention can be of any suitable size and configuration as is known in the art without affecting the overall concept of the invention, provided that it accomplishes the above stated objectives. One of ordinary skill in the art will appreciate that the split hole saw bit device 100 as shown in the FIGS. are for illustrative purposes only, and that many other sizes and shapes of the split hole saw bit device 100 are well within the scope of the present disclosure. Although the dimensions of the split hole saw bit device 100 are important design parameters for user convenience, the split hole saw bit device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A split hole saw bit for drilling circular holes comprising;
a circular saw bit;
a first semi-cylindrical member;
a second semi-cylindrical member;
a nut; and
a center pilot bit;
wherein said first semi-cylindrical member having a first threaded top end member and a first bottom end;
wherein said second semi-cylindrical member having a second threaded top end member and a second bottom end;
said first threaded top end member and said second threaded top end member joined by said nut to secure said first semi-cylindrical member and said second semi-cylindrical member together in an assembled position to form said circular saw bit;
wherein said nut is threaded around said first threaded top end member and said second threaded top end member;
wherein said first bottom end having a plurality of cutting teeth;
wherein said second bottom end having a plurality of cutting teeth;
wherein said first threaded top end member and said second threaded top end member having a central opening;
wherein said center pilot bit passing through said central opening; and
further wherein said center pilot bit having a fluted drill member selectively attachable to said center pilot bit.

2. The split hole saw bit for drilling circular holes of claim 1, wherein said center pilot bit having a stopper for restricting vertical movement of said center pilot bit.

3. The split hole saw bit for drilling circular holes of claim 2, wherein said stopper rigidly fixed to opposing ends of said nut.

4. The split hole saw bit for drilling circular holes of claim 3, wherein said stopper having a first L-shaped arm and a second L-shaped arm, wherein said first L-shaped arm having a first horizontal arm and a first vertical arm, and further wherein said second L-shaped arm having a second horizontal arm and a second vertical arm.

5. The split hole saw bit for drilling circular holes of claim 4, wherein said first vertical arm securable to said first semi-cylindrical member and said second vertical arm securable to said second semi-cylindrical member.

6. The split hole saw bit for drilling circular holes of claim 5, wherein said stopper having a first collar and a second collar, and further wherein said first vertical arm positioned adjacent to said first collar and said second vertical arm positioned adjacent to said second collar.

7. The split hole saw bit for drilling circular holes of claim 6, wherein said first collar positioned on top of said first semi-cylindrical member and said second collar positioned on top of said second semi-cylindrical member.

8. The split hole saw bit for drilling circular holes of claim 7, wherein said fluted drill member having a bottom terminal end, and further wherein said bottom terminal end extending below said first bottom end of said first semi-cylindrical member and said second bottom end of said second semi-cylindrical member.

9. The split hole saw bit for drilling circular holes of claim 8, wherein said first semi-cylindrical member having a first mating edge securable against a first mating edge of said second semi-cylindrical member, and further wherein said first semi-cylindrical member having a second mating edge securable against a second mating edge of said second semi-cylindrical member to form said circular saw bit.

10. The split hole saw bit for drilling circular holes of claim 9, wherein said center pilot bit having a drill head for mounting into a drill chuck of a drill.

11. A split hole saw bit for drilling circular holes comprising;
a circular saw bit;
a first semi-cylindrical member;
a second semi-cylindrical member;
a nut; and
a center pilot bit;
wherein said first semi-cylindrical member having a first threaded top end member and a first bottom end;
wherein said second semi-cylindrical member having a second threaded top end member and a second bottom end;
said first threaded top end member and said second threaded top end member joined by said nut to secure said first semi-cylindrical member and said second semi-cylindrical member together in an assembled position to form said circular saw bit;
wherein said nut is threaded around said first threaded top end member and said second threaded top end member;
wherein said first bottom end having a plurality of cutting teeth;
wherein said second bottom end having a plurality of cutting teeth;
wherein said first threaded top end member and said second threaded top end member having a central opening;
wherein said center pilot bit passing through said central opening; and
further wherein said center pilot bit having a pin sleeve circumscribed by said first semi-cylindrical member and said second semi-cylindrical member for maintaining alignment of said circular saw bit.

12. The split hole saw bit for drilling circular holes of claim 11, wherein further wherein said center pilot bit having a fluted drill member attached to said center pilot bit.

13. The split hole saw bit for drilling circular holes of claim 11, wherein said center pilot bit having a stopper for restricting vertical movement of said center pilot bit.

14. The split hole saw bit for drilling circular holes of claim 13, wherein said stopper rigidly fixed to opposing ends of said nut.

15. The split hole saw bit for drilling circular holes of claim 12, wherein said fluted drill member having a bottom terminal end, and further wherein said bottom terminal end extending below said first bottom end of said first semi-cylindrical member and said second bottom end of said second semi-cylindrical member.

16. The split hole saw bit for drilling circular holes of claim 15, wherein said first semi-cylindrical member having a first mating edge securable against a first mating edge of said second semi-cylindrical member, and further wherein said first semi-cylindrical member having a second mating edge securable against a second mating edge of said second semi-cylindrical member to form said circular saw bit.

17. The split hole saw bit for drilling circular holes of claim 16, wherein said center pilot bit having a drill head for mounting into a drill chuck of a drill.

18. A method of cutting a circular hole in wood, the comprising the steps of:
providing a circular saw bit, a first semi-cylindrical member, a second semi-cylindrical member, a nut; and a center pilot bit, wherein said first semi-cylindrical member having a first threaded top end member and a first bottom end, wherein said second semi-cylindrical member having a second threaded top end member and a second bottom end, wherein said first bottom end having a plurality of cutting teeth, wherein said second bottom end having a plurality of cutting teeth, further wherein said first threaded top end member and said second threaded top end member having a central opening;
joining said first threaded top end member and said second threaded top end member by said nut to secure said first semi-cylindrical member and said second semi-cylindrical member together in an assembled position to form said circular saw bit;
threading said nut around said first threaded top end member and said second threaded top end member;
passing said center pilot bit through said central opening, wherein said center pilot bit having a fluted drill member selectively attachable to said center pilot bit;
securing said center pilot bit to said first semi-cylindrical member and said second semi-cylindrical member;
mounting said central pilot bit into a drill;
entering a wood workpiece initially with said fluted drill member; and
cutting a hole in the wood workpiece with said first semi-cylindrical member and said second semi-cylindrical member.

19. The method of cutting a circular hole in wood of claim 18, further comprising the steps of:
removing said central pilot bit from the drill;
unthreading said nut around said first threaded top end member and said second threaded top end member;
splitting said first semi-cylindrical member and said second semi-cylindrical member; and
removing a sawed piece from said circular saw bit.

20. The method of cutting a circular hole in wood of claim 19, wherein said center pilot bit having a stopper for restricting vertical movement of said center pilot bit, and further wherein said stopper rigidly fixed to opposing ends of said nut.
